(19) United States
(12) Patent Application Publication
(10) Pub. No.: US 2011/0064557 A1
(43) Pub. Date: Mar. 17, 2011

(54) Supply Chain Management System

(75) Inventors: William B. Day, Richmond, TX (US); Kenneth F. Spitler, Houston, TX (US)

(73) Assignee: SYSCO CORPORATION, Houston, TX (US)

(21) Appl. No.: 12/949,126

(22) Filed: Nov. 18, 2010

Related U.S. Application Data
(62) Division of application No. 11/533,387, filed on Sep. 20, 2006.

(51) Int. Cl. B65G 60/00

(52) U.S. Cl. 414/788.8

(57) ABSTRACT

In a method of managing a supply chain from a supplier to a customer by a service company that purchases a product, a plurality of costs corresponding to supply chain parameters and associated with providing a product to a customer is determined. Each of the plurality of costs is stored in a computer database and is associated with a corresponding supply chain parameter. A subset of the plurality of costs is retrieved from the computer database in response to a supply event relative to the product. A total cost for each of a plurality of supply chain permutations is calculated. Each of the plurality of supply chain permutations includes a different combination of supply chain parameters in the supply chain. The supply chain permutation having a lowest total cost is selected. The customer is supplied with the product by employing the selected supply chain permutations.

### CROSS-REFERENCE TO RELATED APPLICATION(S)

This application is a divisional of, and claims the benefit of, U.S. patent application Ser. No. 11/533,387, filed Sep. 20, 2006, the entirety of which is hereby incorporated herein by reference.

### BACKGROUND OF THE INVENTION

1. Field of the Invention

The present invention relates to supply chain management systems and, more specifically, to a system that optimizes actions within a supply chain.

2. Description of the Prior Art

A supply chain is the mechanism through which a product goes from a manufacturer to a consumer and may include a set of suppliers, manufacturers, wholesalers, distributors and stores that enable a product to be made, sold and delivered to the eventual customer. Traditionally, a supply chain for a given product has been formed on a reactive basis: a manufacturer would make a product based on its market predictions; a supplier would place orders for the product based on its market predictions; and a local store would order the product from the supplier based on its market predictions. However, the consumer would purchase the product based on his or her needs or desires. When the buying habits of the consumer changes, the market predictions of the manufacturer, supplier and local store all have to be adjusted. The lag between the changed buying habits of the consumer and the adjustment of the market predictions in the supply chain results in market inefficiency.

Supply chain management is the activity that seeks to minimize inefficiency in a supply chain. It focuses on the management of processes and activities that are used to integrate and manage the activities and resources that impact the supply chain. For example, if handling costs are significant in a portion of a supply chain, then effective supply chain management would seek to minimize such costs. Similarly, inventory carrying costs could have a substantial effect on a supply chain and, therefore, minimizing such costs would also be desirable. Other important factors affecting a supply chain include: transaction costs, transportation costs, transportation delay, insurance costs. These factors may interact with each other. For example, a supplier might be able to minimize the transaction costs associated with a given product by purchasing an extremely large quantity of the product and then storing any units not immediately sold for later sale. However, the inventory carrying costs associated with storing a large quantity of the product might outweigh the savings in the transaction costs.

In recent years, technological advancements have enabled the development of supply chain management applications have opened up a new element of supply chain management. These applications are often referred to as supply chain planning or advanced planning solutions, and they attempt to predict parameters in a supply chain based on such factors as recent experience and market indicators. The goal of these systems is to create plans that minimize total supply chain costs while maintaining desired customer service levels.

A problem that arises in supply chain management is that total supply chain costs aren't necessarily minimized when each individual function (e.g., manufacturing, inventory carrying and transportation) is optimized to its own performance metrics, without considering the interaction of the optimized function with other functions. Such systems fail to assess the many trade-offs across the entire supply chain to support a competitive strategy in the most effective and efficient manner.

Therefore, there is a need for a supply chain management system that integrates many different factors to create an efficient supply chain.

### SUMMARY OF THE INVENTION

The disadvantages of the prior art are overcome by the present invention which, in one aspect, is a method of managing a supply chain from a supplier to a customer by a service company that purchases a product from the supplier and delivers the product to the customer. A plurality of costs associated with providing a product from a supplier to a customer is determined. Each cost corresponds to a plurality of supply chain parameters. Each of the plurality of costs is stored in a computer database and each of the plurality of costs is associated with a corresponding one of the plurality of supply chain parameters. At least a subset of the plurality of costs is retrieved from the computer database in response to a supply event relative to the product. A total cost for each of a plurality of supply chain permutations based on the subset of the plurality of costs is calculated on the computer. Each of the plurality of supply chain permutations includes a different combination of supply chain parameters in the supply chain. A selected one of the plurality of supply chain permutations having a lowest total cost is selected. The customer is supplied with the product by employing the selected one of the plurality of supply chain permutations.

In another aspect, the invention is a regional distribution method, in which a first product is ordered from a first supplier in a first amount. A second product is ordered from a second supplier in a second amount. The first amount is an optimal amount with respect to the first supplier and the second amount is an optimal amount with respect to the second supplier. The first amount of the first product is received from the first supplier at a regional distribution center and the second amount of the second product is received from the second supplier at the regional distribution center. The first amount of the first product is divided into a plurality of first sub-amounts of the first product at the regional distribution center. Each first sub-amount is an optimal amount with respect to a corresponding plurality of operating companies associated with the regional distribution center. Similarly, the second amount of the second product is divided into a plurality of second sub-amounts of the second product, with each second sub-amount being an optimal amount with respect to the corresponding plurality of operating companies associated with the regional distribution center. At the regional distribution center, a selected first sub-amount of the first product optimized with respect to a first operating company is combined with a selected second sub-amount of the second product optimized with respect to the first operating company so as to create a first operating company-specific product load. The first operating company-specific product load is delivered to the first operating company from the regional distribution center.

In yet another aspect, the invention is a regional distribution center that includes an enclosure, a receiving dock, a shipping dock, and an enclosed rail siding. The receiving dock is disposed at a first outer extremity of the enclosure. The shipping dock is disposed at a second outer extremity of the enclosure and spaced apart from the receiving dock. The enclosed rail siding is spaced apart from both the receiving dock and the shipping dock. An automatic depalletizer is disposed adjacent to the receiving dock and is capable of depalletizing products received in pallets from the receiving dock or the enclosed rail siding. An automatic palletizer disposed adjacent to the shipping dock. At least one storage area is disposed between the palletizer and the depalletizer and has access to both the palletizer and the depalletizer. A moving system moves a plurality of products from the shipping dock and the enclosed rail siding to the depalletizer. The moving system is capable of moving depalletized products from the depalletizer to the storage area and is also capable of moving depalletized products from the storage area to the palletizer. The moving system also moves palletized products from the palletizer to the shipping dock.

These and other aspects of the invention will become apparent from the following description of the preferred embodiments taken in conjunction with the following drawings. As would be obvious to one skilled in the art, many variations and modifications of the invention may be effected without departing from the spirit and scope of the novel concepts of the disclosure.

### BRIEF DESCRIPTION OF THE FIGURES OF THE DRAWINGS

FIG. 1 is a schematic diagram of one illustrative embodiment of the invention transposed onto a map.

FIGS. 2A-2B are schematic diagrams showing the relationships between several entities.

FIG. 3 is a schematic diagram showing a depalletizing-repalletizing operation at a regional distribution center.

FIGS. 4A-4E is a schematic diagram and several tables used to demonstrate an supply chain optimization method employed in one embodiment of the invention.

FIG. 5 is a top plan view of a regional distribution center.

### DETAILED DESCRIPTION OF THE INVENTION

A preferred embodiment of the invention is now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.”

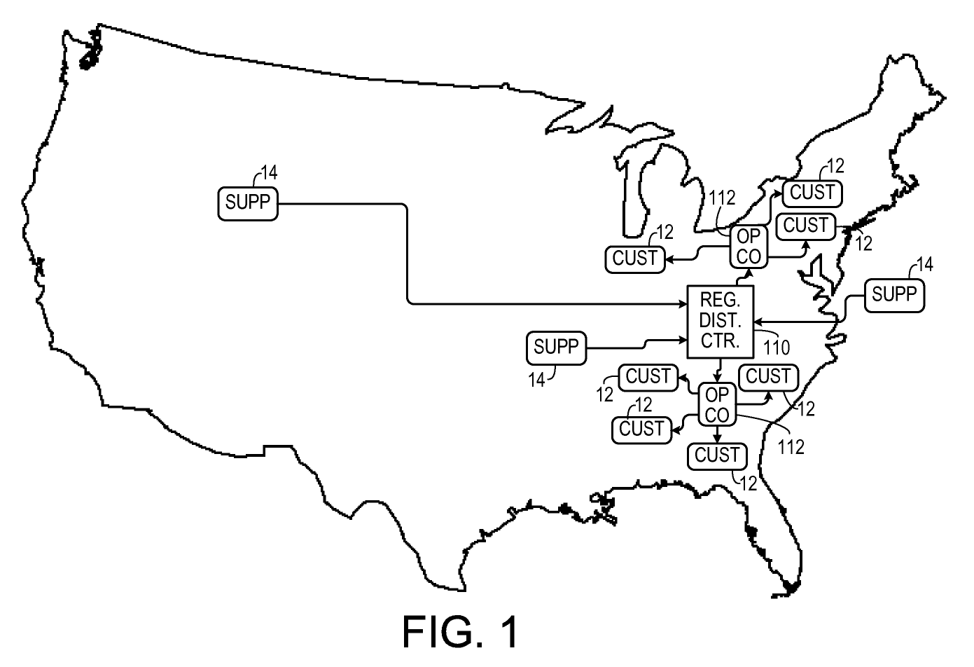

As shown in FIG. 1, in one illustrative embodiment of the invention, a plurality of geographically diverse suppliers 14 supply goods to a regional distribution center (RDC) 110 in quantities that are optimal with respect to the RDC 110. The RDC 110 reorganizes the goods into quantities that are optimal for each of a plurality of operating companies 112, who then distribute the goods to a plurality of wholesale customers 12. The wholesale customers 12 then distribute the goods to their respective retail customers. The RDC 110 is located at a location such that shipping to the operating companies 112 can occur within a predetermined period of time, such as one 24 hour period.

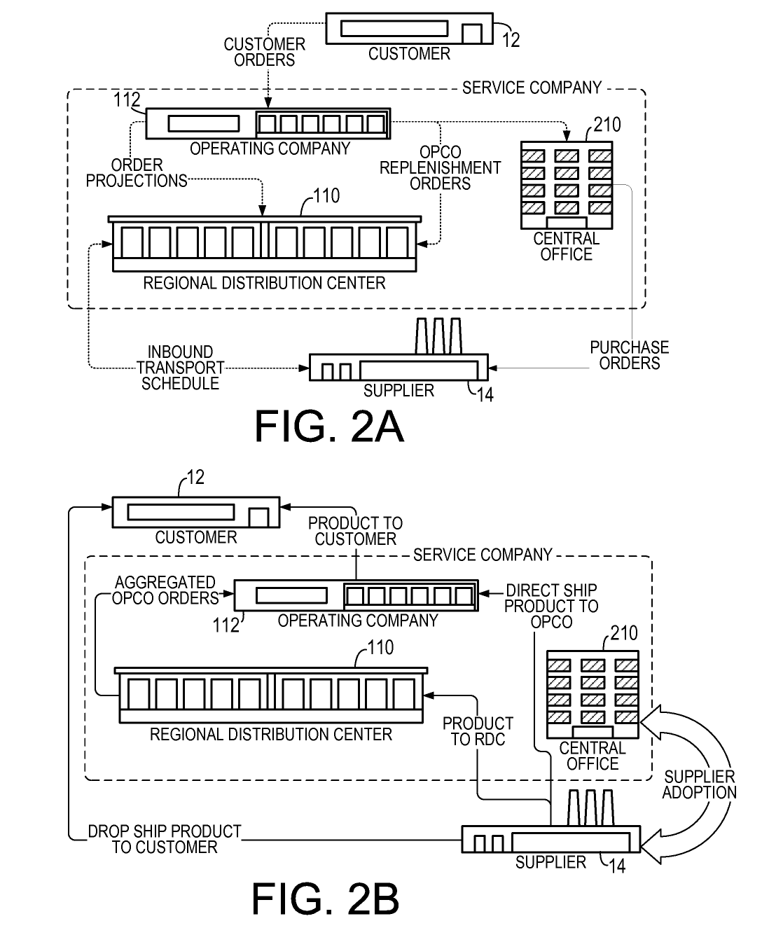

The ordering, scheduling and control relationships between the various entities involved in the invention are shown in FIG. 2A. Typically, a wholesale customer 12 orders, from an operating company 112, a quantity of a product sufficient to meet the needs of its customers over a given period. For example, if the wholesale customer 12 was a restaurant that orders paper napkins, then the operating company 112 could be a restaurant supply company that supplies paper napkins Periodically, the operating company 112 transmits order projections to the RDC 110. Such order projections could be based on several factors, for example: seasonal expectations of required quantities of the products it provides to its customers; expectations based on market growth; expectations based short term anticipated events (e.g., an announcement of a major sporting event coming to the operating company's territory might trigger an increased expectation of the need for paper cups); and ordering trends of current customers. When the operating company 112 anticipates that its stock of a certain item falls below a preset threshold, it will also send a replenishment order to the RDC 110. The order projections may also be transmitted to a central office 210 for statistical analysis and the replenishment orders may also be sent to the central office 210 so that it may issue a purchase order to the supplier 14. The supplier 14 transmits a transportation schedule to the RDC 110 to indicate when shipments to the other entities can be expected.

An exemplary delivery scheme from the supplier 14 is shown in FIG. 2B. The supplier 14 may ship directly to the RDC 110, in which case the RDC 110 delivers aggregated orders to the operating company 112. The operating company 112 then ships customer-specific orders to the wholesale customer 12. If it is determined to be optimal, then the supplier may also ship directly to the operating company 112 or to the customer 12. (This situation could arise, for example, when either the operating company 112 or the wholesale customer 12 orders an entire truckload of a product.)

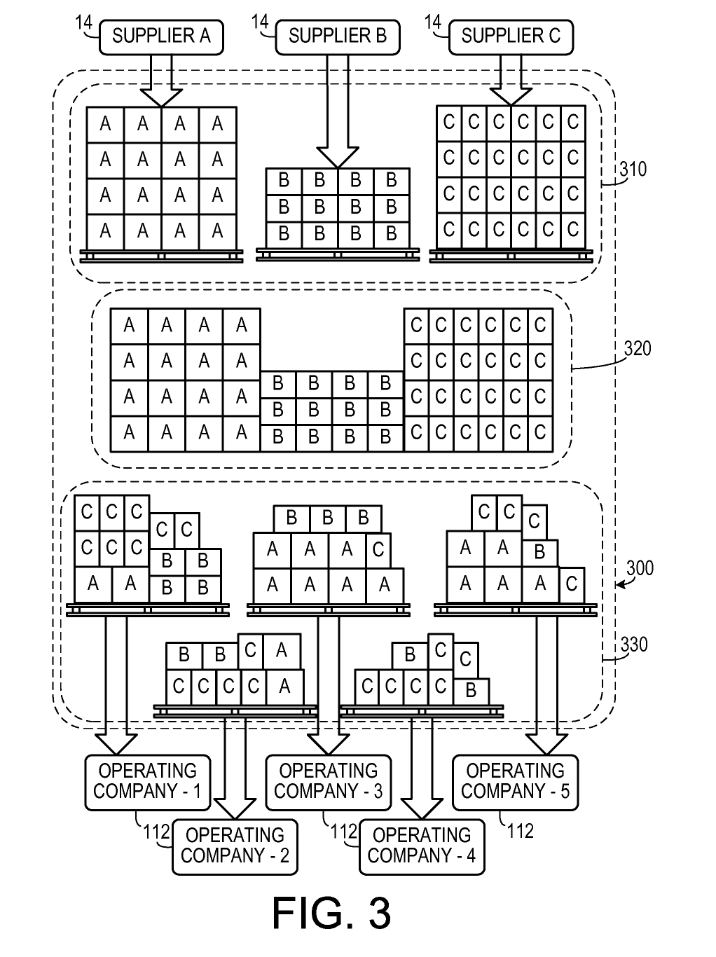

An aggregation system 300 that would be employed at the RDC 110 is shown in FIG. 3, in which products are ordered in supplier-optimal amounts from various suppliers 14. Typically, a supplier-optimal amount is an amount for which the unit price of the product is minimal—such as an entire pallet or an entire truckload of the product. Also, truck volumes and routs may be optimized to minimize transport costs for the first product and the second product. This results in an amount that reflects the reduced per-unit handling and transportation charges associated with the product, a well as a bulk ordering incentive to the supplier 14. The supplier-optimal amounts of the products are received in a receiving area 310 and they are disassembled and placed in a storage area 320. Subsequently, they are then reassembled into operating company-optimal amounts in a loading area 330. The company-optimal amounts are amounts that are optimal to the individual operating companies 112. For example, it may be cheapest to purchase a 16 unit pallet of product “A” from supplier “A,” a 12 unit pallet of product “B” from supplier “B” and a 36 unit pallet of product “C” from supplier “C.” However, it might be most efficient to supply operating company “1” with only two units of product “A,” four units of product “B” and eight units of product “C” for a given shipment. This shipment to operating company “1” would take into account such factors as operating company “1's” projected needs and warehousing capacity, as well as the transportation costs associated with the shipment. Similar operating company-specific shipments could be assembled for other operating companies. Thus, the RDC ensures that products are ordered in a manner so as to optimize the efficiency of ordering from the suppliers 14 and the products are aggregated in a manner so as to optimize the efficiency of transporting the products to the operating companies. supplier-optimal amounts 112.

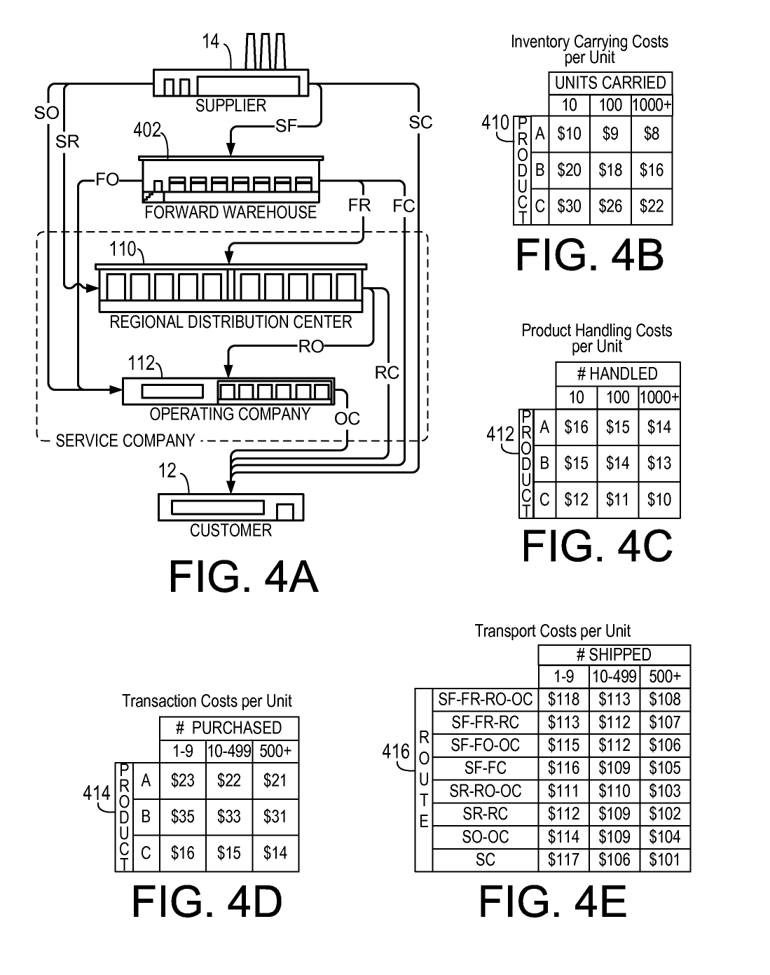

One demonstration of an exemplary manner in which the ordering and transport decisions are made is shown in FIGS. 4A-4E. Various supply chain permutations are shown in FIGS. 4A-4E. The costs associated with each of these permutations a stored in a computer database by a digital computer. Possible transportation leg combinations are shown in FIG. 4A, in which each leg of a transportation chain between the supplier 14 and the customer is designated by a two-letter code, as follows:
SF—the supplier 14 ships to a forward warehouse 402;
SR—the supplier 14 ships to the RDC 110;
SO—the supplier 14 ships to the operating company 110;
SC—the supplier 14 ships to the wholesale customer 12;
FR—the forward warehouse 402 ships to the RDC 110;
FO—the forward warehouse 402 ships to the operating company 110;
FC—the forward warehouse 402 ships to the wholesale customer 12;
RO—the RDC 110 ships to the operating company 110;
RC—the RDC 110 ships to the wholesale customer 12; and
OC—the operating company 110 ships to the wholesale customer 12.
   Various combinations of these legs form different permutations of the supply chain. For example, SR-RO-OC denotes a transportation chain where the supplier 14 ships a product to the RDC 110 (the “SR” leg), which ships the product to the operating company 112 (the “RO” leg), which in turn ships the product to the wholesale customer 12 (the “OC” leg). A cost is determined 416 for each of these transport permutations, in view of various quantities ordered, as shown in FIG. 4E. Other costs are also calculated for other supply chain parameters. For example, FIG. 4B shows exemplary per unit inventory carrying costs 410 associated with several products as a function of the number of units carried (such as at the RDC 110). In another example, as shown in FIG. 4C, per unit handling costs 412 are determined as a function of the number of units handled for each product, and FIG. 4D shows that per unit transaction costs 414 are determined for each product as a function of the number of units of the product purchased. These costs may be determined based on experience and on the result of negotiations with the entities involved. For example, the transport costs might be determined based on a carrying contract negotiated with a trucking company and transaction costs might be based on the supplier's 14 product price list for the service company.

When an order is to be sent to a customer 12, the costs associated with the various permutations are added together to generate a total supply chain cost for each supply chain permutation. A computer retrieves from the database all of the relevant costs and calculates a total supply chain cost for each supply chain permutation. The supply chain permutation with the lowest supply chain cost is then selected. For example, if the customer 12 ordered 300 units of product A, and if the service company were to order only that amount, then the transaction cost would be $22×300=$6,600, the inventory handling cost would be $9×300=$2,700, the product handling costs would be $15×300=$4,500 and the lowest transport cost would be (using route SC) $106×300=$31,800. Thus, the total cost for this supply chain permutation would be $6,600+$2,700+$4,500+$31,800=$45,600 and the total per unit cost would be $45,600÷300=$152 per unit.

The service company might consider ordering 1000 units instead, assuming that there is a high probability that the additional 1000 units would be ordered by customers in the near term, with 500 units being stored at the RDC 110 and 200 units being stored at the operating company 112. In this case, the transaction cost would be $21×1,000=$21,000, the inventory handling cost would be $8×1,000=$8,000, the product handling costs would be $14×1,000=$14,000, the lowest transport cost would be (this time using route SR-RO-OC because 500 units would have to be shipped to the RDC 110 and 200 units would have to be shipped to the operating company 112 for storage) $110×1,000=$110,000. Thus, the total cost for this supply chain permutation would be $21,000+$8,000+$14,000+$110,000=$153,000 and the total per unit cost would be $153,000÷1,000=$153 per unit. However, this bulk ordering would result in an actually higher supply chain cost per unit ($153 per unit) than the cost per unit of ordering only 300 units ($152 per unit). Therefore, the service company would order only 300 units of product A. As will be readily appreciated, this is only a greatly simplified example and an actual embodiment might include many other factors (such as safety stock cost, etc.) commonly known to those in the supply chain management art. Also, supply chain events other than receiving an order from the customer could trigger this kind of calculation.

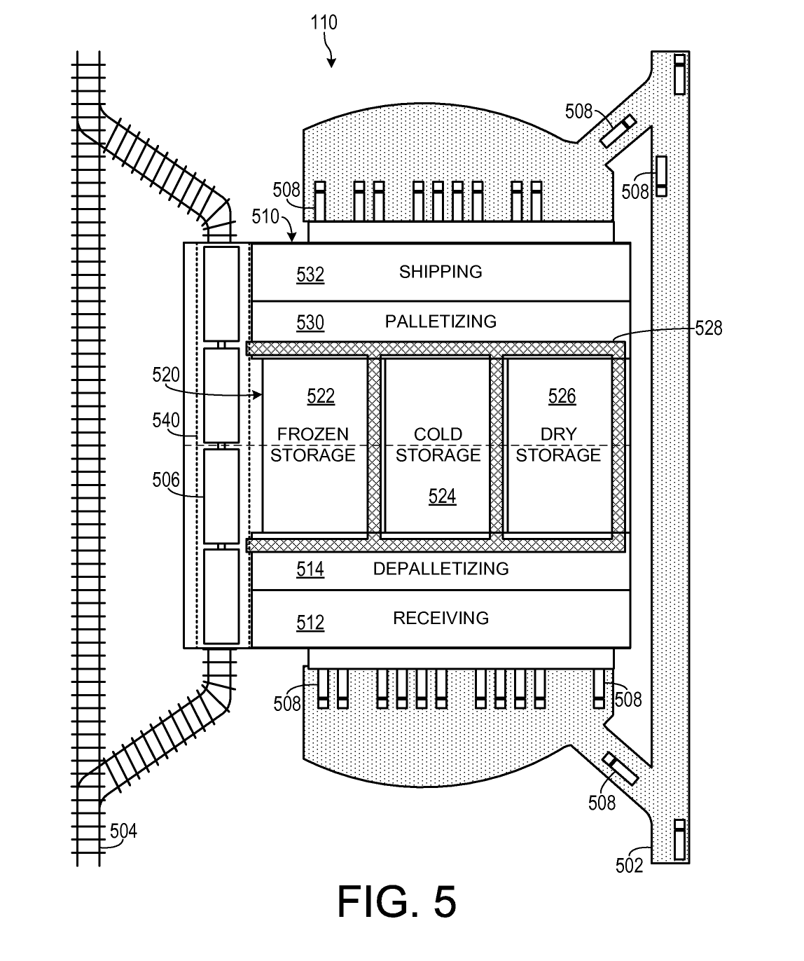

One configuration for an RDC 110 is shown in FIG. 5. Ideally, the RDC 110 is located close to one or more substantial transportation channels, such as a major highway 502, allowing truck 508 transportation, and a railway 504, allowing train 506 transportation, or even an airport (not shown). The regional distribution center 110 would include a substantial enclosure 510. A receiving dock 512 would be located at a first outer extremity of the enclosure 110. The receiving dock 512 would be positioned so as to receive inbound trucks 508, carrying supplier-optimal loads, from the highway 502. A shipping dock 532 would be located at a second outer extremity of the enclosure 110 and would be spaced apart from the receiving dock 512. The shipping dock 532 would be positioned for efficient access to the highway 502 for outbound trucks 508 carrying customer-optimal loads.

An enclosed rail siding 540, spaced apart from both the receiving dock 512 and the shipping dock 532, would allow receipt of goods from trains 506, as well a shipping goods via train 506. Located next to the receiving dock 512 would be a depalletizing area 514 that would house an automatic depalletizer. Next to the depalletizing area is a storage unit 520, that could include three separate storage areas: (1) a frozen storage area 522 for storing frozen perishable goods (e.g., frozen meat, frozen vegetables, etc.); (2) a cold storage area 524, for storing refrigerated perishable goods (e.g., dairy products, fresh vegetables, etc.); and (3) a dry storage area 526, for storing non-perishable goods (e.g., paper napkins, plastic cutlery, etc.). Each storage area would include a plurality of vertically spaced-apart racks (not shown) for storing products thereon.

An automatic depalletizer would be located in the depalletizing area 514 and would be used for depalletizing products received in pallets from the receiving dock 512 or the enclosed rail siding 540. A palletizing area 530 would be located between the shipping dock 532 and the storage areas and an automatic palletizer would be located in the palletizing area 530. The palletizer would be used to configure customer-optimal loads for transfer onto trucks 508 at the shipping dock 532 or trains 506 in the enclosed rail siding 540.

A moving system 528, such as a conveyor system moves products from the receiving dock 512 and the enclosed rail siding 540 to the depalletizer 514 and moves depalletized products from the depalletizer 514 to a selected storage area of the storage unit 520. The moving system 528 would also move depalletized products from the storage area 520 to the palletizer 530 and would move palletized products from the palletizer 530 to the shipping dock 532.

The above described embodiments are given as illustrative examples only. It will be readily appreciated that many deviations may be made from the specific embodiments disclosed in this specification without departing from the invention. Accordingly, the scope of the invention is to be determined by the claims below rather than being limited to the specifically described embodiments above.

What is claimed is:

1. A regional distribution center, comprising:
a. an enclosure;
b. a receiving dock disposed at a first outer extremity of the enclosure;
c. a shipping dock disposed at a second outer extremity of the enclosure and spaced apart from the receiving dock;
d. an enclosed rail siding, spaced apart from both the receiving dock and the shipping dock;
e. an automatic depalletizer disposed adjacent to the receiving dock and capable of depalletizing products received in pallets from the receiving dock or the enclosed rail siding;
f. an automatic palletizer disposed adjacent to the shipping dock;
g. at least one storage area disposed between the palletizer and the depalletizer and having access to both the palletizer and the depalletizer; and
h. a moving system that moves a plurality of products from the receiving dock and the enclosed rail siding to the depalletizer and that moves depalletized products from the depalletizer to the storage area, and that also moves depalletized products from the storage area to the palletizer and that also moves palletized products from the palletizer to the shipping dock.

2. The regional distribution center of claim 1, wherein the storage are comprises a plurality of vertically spaced-apart racks.

3. The regional distribution center of claim 1, wherein the storage are comprises a frozen storage area.

4. The regional distribution center of claim 1, wherein the storage are comprises a cold storage area.

5. The regional distribution center of claim 1, wherein the storage are comprises a dry storage area.
